(19) United States
(12) Patent Application Publication
(10) Pub. No.: US 2024/0037153 A1
(43) Pub. Date: Feb. 1, 2024

(54) SYSTEMS AND METHODS FOR GENERATING CANDIDATE RECOMMENDATIONS

(71) Applicant: Meta Platforms, Inc., Menlo Park, CA (US)

(72) Inventors: Hailing Cheng, San Jose, CA (US); Jing Ma, San Jose, CA (US); Miaoqing Fang, Menlo Park, CA (US); Huihong Zhao, Fremont, CA (US)

(21) Appl. No.: 16/593,883

(22) Filed: Oct. 4, 2019

(51) Int. Cl. G06F 16/9035; G06Q 10/10; G06F 16/909; G06F 16/908; G06N 20/00

(52) U.S. Cl. CPC G06F 16/9035; G06Q 10/1053; G06F 16/909; G06F 16/908; G06N 20/00

(57) ABSTRACT

Systems, methods, and non-transitory computer-readable media can be configured to determine a set of candidates based at least in part on filtering criteria. A subset of candidates can be determined from the set of candidates based at least in part on one or more recruiter features associated with a recruiter. A recommendation can be provided to the recruiter for a candidate from among the subset of candidates based at least in part on a ranking of the subset of candidates.

### FIELD OF THE INVENTION

The present technology relates to the field of machine learning. More particularly, the present technology relates to techniques for generating candidate recommendations based on multi-stage machine learning methodologies.

### BACKGROUND

Today, people often utilize computing devices (or systems) for a wide variety of purposes. For example, an online platform can allow organizations to publish job requisitions seeking candidates for available job positions at the organization. Potential candidates can apply for the published job requisitions by providing information about their experience and qualifications, for example, by submitting resumes. In some cases, an organization may have a large number of available job positions and, accordingly, publish a large volume of job requisitions. As a result, the large organization may receive a large volume of resumes. The large volumes of job requisitions published and the large volumes of resumes received can create challenges with regard to evaluating the large volumes of resumes and identifying qualified job candidates.

### SUMMARY

Various embodiments of the present technology can include systems, methods, and non-transitory computer readable media configured to determine a set of candidates based at least in part on filtering criteria. A subset of candidates can be determined from the set of candidates based at least in part on one or more recruiter features associated with a recruiter. A recommendation can be provided to the recruiter for a candidate from among the subset of candidates based at least in part on a ranking of the subset of candidates.

In some embodiments, the set of candidates can comprise candidates that have been claimed by the recruiter but have not been contacted by the recruiter within a threshold period of time.

In some embodiments, the set of candidates can comprise candidates determined to be similar to candidates previously considered by the recruiter.

In some embodiments, the filtering criteria can be based on at least one of: a minimum amount of experience, a geographical location, a tag, or a review.

In some embodiments, the determining the subset of candidates from the set of candidates can comprise filtering candidates that the recruiter has previously viewed and not claimed.

In some embodiments, the determining the subset of candidates from the set of candidates can be further based at least in part on an affinity between the recruiter and each candidate in the set of candidates.

In some embodiments, the determining the subset of candidates from the set of candidates can be further based at least in part on whether each candidate satisfies a threshold affinity.

In some embodiments, the ranking of the subset of candidates can be based at least in part on a likelihood to pass an interview of each candidate in the subset of candidates, wherein the likelihood to pass is determined based at least in part on a trained machine learning model.

In some embodiments, the ranking of the subset of candidates can be based at least in part on an overall quality of each candidate in the subset of candidates, wherein the overall quality is determined based at least in part on a trained machine learning model.

In some embodiments, the providing the recommendation to the recruiter can be further based at least in part on whether the candidate satisfies a threshold ranking.

It should be appreciated that many other features, applications, embodiments, and/or variations of the present technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example system including an example candidate recommendation module, according to an embodiment of the present technology.

FIG. 2A illustrates an example targeting filtering module, according to an embodiment of the present technology.

FIG. 2B illustrates an example personalization module, according to an embodiment of the present technology.

FIG. 3 illustrates an example functional block diagram, according to an embodiment of the present technology.

FIG. 4 illustrates an example interface, according to an embodiment of the present technology.

FIG. 5 illustrates an example process for providing a recommendation for a candidate, according to an embodiment of the present technology.

FIG. 6 illustrates a network diagram of an example system including an example social networking system that can be utilized in various scenarios, according to an embodiment of the present technology.

FIG. 7 illustrates an example of a computer system or computing device that can be utilized in various scenarios, according to an embodiment of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

### Approaches for Generating Candidate Recommendations

Today, people often utilize computing devices (or systems) for a wide variety of purposes. For example, an online platform can allow organizations to publish job requisitions seeking candidates for available job positions at the organization. Potential candidates can apply for the published job requisitions by providing information about their experience and qualifications, for example, by submitting resumes. In some cases, an organization may have a large number of available job positions and, accordingly, publish a large volume of job requisitions. As a result, the large organization may receive a large volume of resumes. The large volumes of job requisitions published and the large volumes of resumes received can create challenges with regard to evaluating the large volumes of resumes and identifying qualified job candidates.

Under conventional approaches, an organization can publish a requisition to an online platform to find suitable candidates for an available job position at the organization. Potential candidates can respond to the requisition by providing information describing their experience and qualifications to the online platform, for example, by submitting resumes. To identify qualified candidates from among the potential candidates, the organization can utilize a recruiter who understands what qualifications are important for the available job position. The recruiter can individually evaluate resumes submitted by the potential candidates and identify which of the potential candidates are qualified for the job position. However, under conventional approaches, individually evaluating resumes and identifying qualified candidates can present significant challenges. For example, a large organization may have a large number of available job positions and, accordingly, publish a large volume of requisitions. As a result, the large organization may receive a large volume of resumes submitted by potential candidates. Individually evaluating each resume in the large volume of resumes can present significant challenges in terms of efficacy and scalability. Further, in some cases, a large organization may utilize a large number of recruiters who may vary in their abilities to identify qualified candidates for various job positions. In this regard, a recruiter that is not well suited for identifying qualified candidates for a particular job position can create inefficiencies. These inefficiencies arise, not only in relation to the recruiter, but also in relation to other recruiters who may be better suited for identifying qualified candidates for the particular job position. These challenges of efficiency become exacerbated as volumes of requisitions and volumes of received resumes increase. Thus, conventional approaches, such as those described, are not effective in addressing these and other problems arising in computer technology.

An improved approach rooted in computer technology overcomes the foregoing and other disadvantages associated with conventional approaches specifically arising in the realm of computer technology. In various embodiments, the present technology provides for generating candidate recommendations for recruiters. The candidate recommendations can be generated using a multi-stage combination of machine learning methodologies and rule-based methodologies. In some embodiments, the present technology can generate, using a trained machine learning model, candidate embeddings for candidates. Candidate embeddings can be numerical representations (e.g., vectors) of candidates. Candidate embeddings and recruiter embeddings can be mapped in a vector space and compared to determine various interrelationships among the candidate embeddings and respective candidates. For example, candidate embeddings that are close in proximity when mapped in a vector space can correspond with candidates that are similar in qualifications. In some embodiments, the present technology, in one stage of the multi-stage combination, can generate an initial pool of candidates. The initial pool of candidates can be generated from one or more sources utilizing machine learning methodologies, rule-based methodologies, or a combination of methodologies. For example, using a machine learning methodology, the present technology can identify candidates who are similarly qualified for a requisition based on respective candidate embeddings associated with the candidates. The identified candidates can be included in an initial pool of candidates. The present technology, in another stage of the multi-stage combination, can refine an initial pool of candidates. The initial pool of candidates can be refined using one or more rule-based methodologies. For example, search filters and operational filters can be utilized to refine an initial pool of candidates. The present technology, in yet another stage of the multi-stage combination, can personalize a refined pool of candidates for a recruiter. The refined pool of candidates can be personalized using machine learning methodologies, rule-based methodologies, or a combination of methodologies. For example, a refined pool of candidates can be personalized based on recruiter embeddings generated for recruiters. Recruiter embeddings can be numerical representations (e.g., vectors) of recruiters. Recruiter embeddings can be mapped in a vector space along with candidate embeddings to determine affinities among respective recruiters and candidates. The present technology, in yet still another stage of the multi-stage combination, can rank a personalized pool of candidates. The personalized pool of candidates can be ranked using one or more machine learning methodologies. For example, a trained machine learning model can rank a personalized pool of candidates based on a likelihood that each candidate will pass an interview. The highest ranked candidates can correspond with candidates who are likely to pass an interview and can be recommended to a recruiter. Additional details relating to the present technology are provided below.

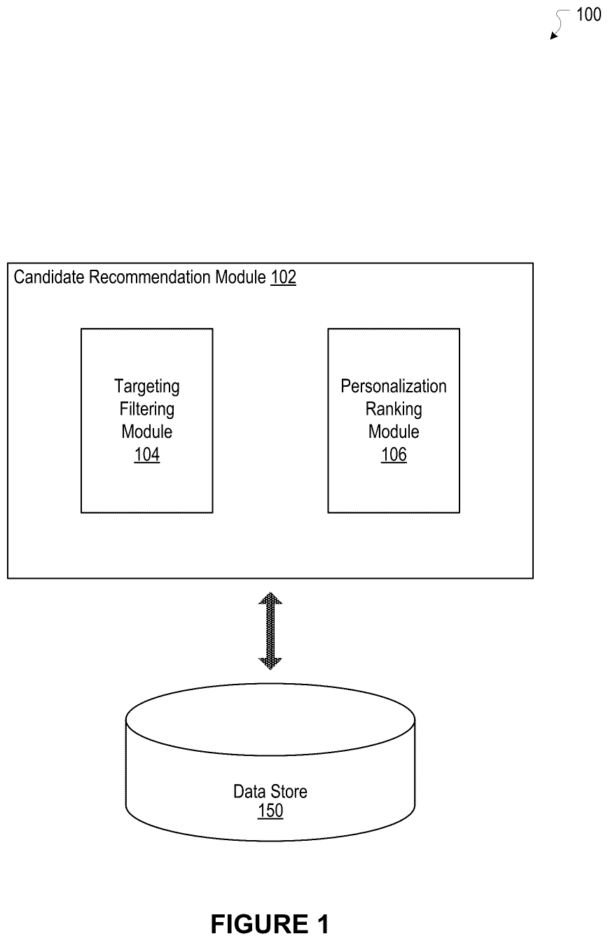

FIG. 1 illustrates an example system 100 including an example candidate recommendation module 102, according to an embodiment of the present technology. As shown in the example of FIG. 1, the candidate recommendation module 102 can include a targeting filtering module 104 and a personalization ranking module 106. In some embodiments, the example system 100 can include one or more data store(s) 150. The components (e.g., modules, elements, etc.) shown in this figure and all figures herein are exemplary only, and other implementations may include additional, fewer, integrated, or different components. Some components may not be shown so as not to obscure relevant details.

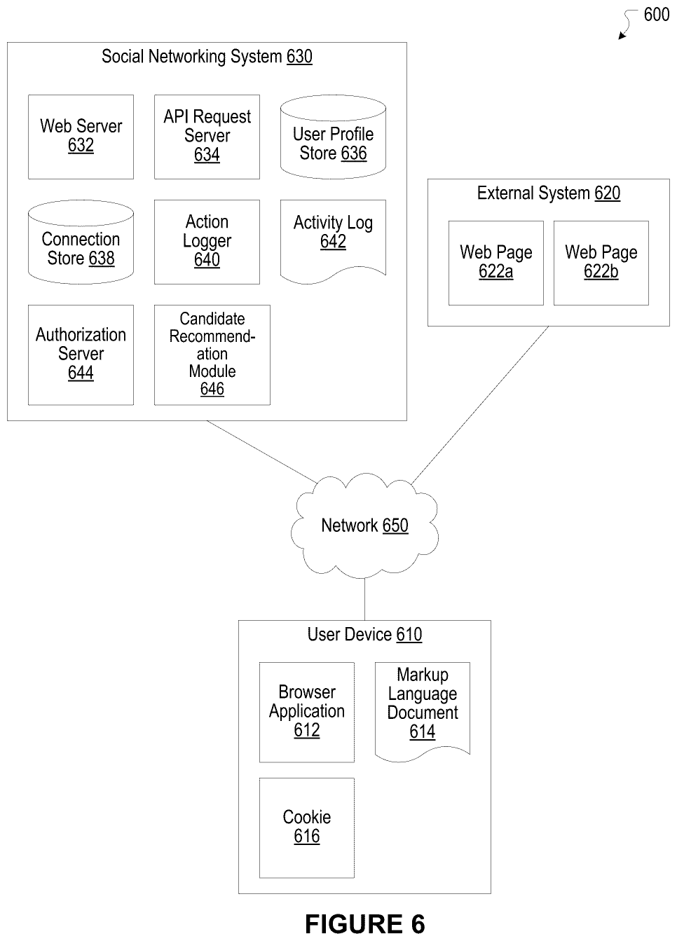

In some embodiments, the candidate recommendation module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some embodiments, the candidate recommendation module 102 can be, in part or in whole, implemented within or configured to operate in conjunction with or be integrated with a social networking system (or service), such as a social networking system 630 of FIG. 6. Likewise, in some instances, the candidate recommendation module 102 can be, in part or in whole, implemented within or configured to operate in conjunction with or be integrated with a client computing device, such as the user device 610 of FIG. 6. For example, the candidate recommendation module 102 can be implemented as or within a dedicated application (e.g., app), a program, or an applet running on a user computing device or client computing system. The application incorporating or implementing instructions for performing functionality of the candidate recommendation module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The candidate recommendation module 102 can be configured to communicate and/or operate with the at least one data store 150, as shown in the example system 100. The at least one data store 150 can be configured to store and maintain various types of data including, for example, requisitions and recruiter embeddings. In some implementations, the at least one data store 150 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 150 can store information associated with users, such as user identifiers, user information, profile information, user specified settings, content produced or posted by users, and various other types of user data.

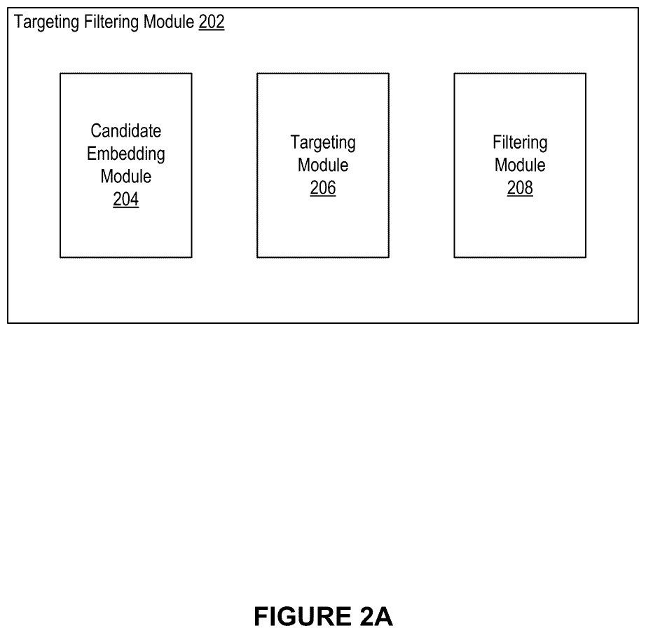

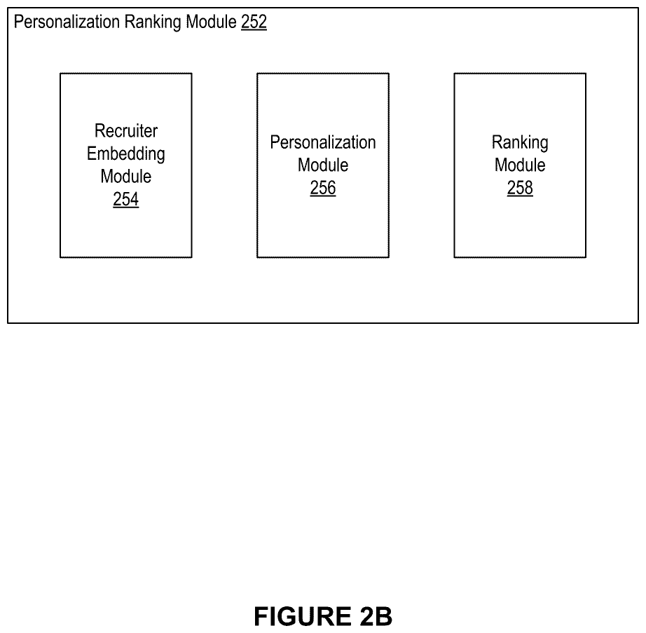

In various embodiments, the targeting filtering module 104 can generate an initial pool of candidates and refine the initial pool of candidates. The initial pool of candidates generated by the targeting filtering module 104 can include candidates who are qualified for a requisition. The targeting filtering module 104 can generate the initial pool of candidates using machine learning methodologies, rule-based methodologies, or a combination of methodologies. The initial pool of candidates can include candidates from a variety of sources. In some embodiments, the targeting filtering module 104 can generate an initial pool of candidates based on candidate embeddings generated for candidates. The targeting filtering module 104 can generate candidate embeddings for candidates based on candidate features associated with the candidates. In addition, or alternatively, the targeting filtering module 104 can generate an initial pool of candidates based on one or more rules. For example, one rule can provide that candidates that were previously considered for other requisitions can be included in the initial pool of candidates. Based on machine-learning methodologies, rule-based methodologies, or a combination of methodologies, the targeting filtering module 140 can generate an initial pool of qualified candidates that can be further refined in subsequent steps. In some embodiments, the targeting filtering module 104 can refine an initial pool of candidates using one or more rule-based methodologies. More details regarding the targeting filtering module 104 will be provided with reference to FIG. 2A.

In various embodiments, the personalization ranking module 106 can personalize a refined pool of candidates and rank the personalized pool of candidates. The refined pool of candidates can be personalized using one or more machine learning methodologies. In some embodiments, the personalization ranking module 106 can generate a recruiter embedding for a recruiter. The recruiter embedding can be generated based on candidate features that describe a candidate for whom the recruiter has an affinity. The personalization ranking module 106 can personalize a refined pool of candidates based on a recruiter embedding for a recruiter. In some embodiments, the personalization ranking module 106 can rank a personalized pool of candidates. The personalized pool of candidates can be ranked using one or more machine learning methodologies. More details regarding the personalization ranking module 106 will be provided with reference to FIG. 2B.

FIG. 2A illustrates an example of a targeting filtering module 202 configured to generate an initial pool of candidates and refine the initial pool of candidates, according to an embodiment of the present technology. In some embodiments, the targeting filtering module 202 can be configured to generate candidate embeddings for candidates. Generating an initial pool of candidates can be based on candidate embeddings. In some embodiments, the targeting filtering module 104 of FIG. 1 can be implemented as the targeting filtering module 202. As shown in FIG. 2, the targeting filtering module 202 can include a candidate embedding module 204, a targeting module 206, and a filtering module 208.

The candidate embedding module 204 can generate candidate embeddings for candidates in a vector (or embedding) space based on various candidate features associated with the candidates. Candidate features can be based on information related to educational histories, professional experiences, and qualifications of candidates such as education, prior experiences, prior job titles, prior projects, skills, and certifications. Such information can be obtained, for example, through a resume, a form, or an online data source, such as a professional networking website or social networking system. The candidate embedding module 204 can generate candidate embeddings based on various machine learning methodologies. The candidate embedding module 204 can train a machine learning model and apply the machine learning model to generate candidate embeddings for candidates. The machine learning model can be trained with a training set of data including candidate features so that candidates that are relatively similar have associated embeddings that are relatively closer in the vector space and candidates that are relatively dissimilar have associated embeddings that are relatively farther. For example, the machine learning model can be trained with a training set of data based on candidate features of past candidates. The training set of data can include past candidates who were considered for the same requisition as examples of candidates with similar candidate features and past candidates who were considered for different requisitions as examples of candidates with dissimilar candidate features. The trained machine learning model can be applied, for example, to a resume of a potential candidate and generate a candidate embedding for the potential candidate. In general, candidate embeddings can be numerical representations (e.g., vectors) of candidate features associated with candidates. The candidate embeddings can be mapped to a vector space and compared with other candidate embeddings to determine various interrelationships among the candidate embeddings and the respective candidates. Candidates with candidate embeddings that are closer in proximity may have more similar features than candidates with candidate embeddings that are farther in proximity. Many variations are possible.

The targeting module 206 can generate an initial pool of candidates from one or more sources based on machine learning methodologies, rule-based methodologies, or a combination of methodologies. Examples of sources of candidates can include current potential candidates, previously considered candidates, and hired candidates. In some embodiments, the targeting module 206 can use a trained machine learning model to generate an initial pool of candidates based on candidate embeddings corresponding to the candidates. Candidate embeddings of candidates from one or more sources can be mapped to a vector space and, based on a proximity between the candidate embeddings, similar candidates can be identified. An initial pool of candidates can be generated based on the similar candidates. For example, a recruiter may have considered (e.g., contacted, screened, interviewed, hired, or otherwise taken action with respect to) a potential candidate for a requisition. A candidate embedding of the considered candidate and candidate embeddings of other potential candidates can be mapped to a vector space. Candidate embeddings within a threshold proximity of the candidate embedding of the considered candidate can correspond with potential candidates that are similarly qualified as the considered candidate. The similarly qualified potential candidates can be included in an initial pool of candidates.

In some embodiments, the targeting module 206 can use one or more rules to generate an initial pool of candidates. In one embodiment, the targeting module 206 can employ a rule that candidates that have been claimed (i.e., tagged for consideration by a recruiter) but were not contacted within a threshold period of time (e.g., 30 days) are included in an initial pool of candidates. For example, candidates that have been claimed by a recruiter but have not been contacted by the recruiter in thirty days can be included in an initial pool of candidates. In one embodiment, the targeting module 206 can employ a rule that candidates that have been considered for a requisition within a pipeline (i.e., category of requisitions) are included in an initial pool of candidates for other requisitions within the pipeline. For example, candidates who have been considered for a requisition within a pipeline of requisitions can be included in an initial pool of candidates for other requisitions within the pipeline.

In some embodiments, the targeting module 206 can use a combination of machine learning methodologies and rule-based methodologies to generate an initial pool of candidates. The targeting module 206 can use one or more trained machine learning models to identify similar requisitions and similar candidates. Such machine learning models can be trained to identify similar requisitions and similar candidates based on training sets of data including requisitions or candidates that have been labeled as similar, or they can be trained using one or more of the methodologies described above. The one or more trained machine learning models can be used in combination with one or more rules to generate an initial pool of candidates. For example, a recruiter may have considered (e.g., contacted, screened, interviewed, hired, etc.) a potential candidate for a particular requisition within a pipeline. Candidates that have been considered for other requisitions within the pipeline can be included in an initial pool of candidates. Additionally, a trained machine learning model can identify candidates that are similar to the considered candidates and the similar candidates can be included in the initial pool of candidates. Further, a trained machine learning model can identify requisitions similar to the particular requisition, and candidates considered for the similar requisitions can be included in the initial pool of candidates. Accordingly, the initial pool of candidates can include candidates from a variety of sources and based on a variety of methodologies. Many variations are possible.

The filtering module 208 can refine an initial pool of candidates based on one or more rule-based filters. In some cases, the one or more rule-based filters can be based on a classification of candidate features associated with candidates in an initial pool of candidates. The filtering module 208 can classify candidate features including job experience, job titles, education, and other qualifications into multiple categories. The filtering module 208 can use a language parser to identify key words from a resume submitted by a candidate and classify candidate features based on the key words. For example, the filtering module 208 can use a language parser to categorize job titles and associated years of experience from a resume submitted by a candidate. The language parser can eliminate prefixes (e.g., principle, lead, senior, staff, associate, etc.) and suffixes (e.g., team, department, 1, 2, 3, etc.) from job titles identified from the resume. The job titles and associated years of experience can be classified into different categories of candidate features. The different categories of candidate features can be represented as a vector of numerical values and each numerical value in the vector can correspond with an amount of experience for a respective category. For example, a candidate with 3 years of experience as a software engineer, 2 years of experience as a product designer, and 1 year of experience as a data scientist can be represented as a vector representing categories of candidate features associated with the candidate. The vector can be, for example, [3, 2, 1, 0, 0, . . . ], where the “3” corresponds with the 3 years of experience as a software engineer, the “2” correspond with the 2 years of experience as a product designer, the “1” represents the 1 year of experience as a data scientist, and the subsequent “0”s represent 0 years of experience in other job titles. Many variations are possible.

In some embodiments, the filtering module 208 can use one or more rule-based search filters or operational filters to refine an initial pool of candidates. Search filters can correspond with a minimum amount of experience associated with a requisition. For example, an initial pool of candidates may include a number of potential candidates for a requisition. The requisition may be associated with a minimum amount of experience associated with a job role. The filtering module 208 can filter candidates from the initial pool of candidates that do not satisfy the minimum amount of experience associated with the job role. Search filters also can correspond with a geographical location. Candidates in an initial pool of candidates who are located outside a threshold proximity of a geographical location associated with a requisition can be filtered. In some cases, a recruiter can specify various search filters and the filtering module 208 can filter an initial pool of candidates based on the specified search filters. Operational filters can filter extraneous candidates in an initial pool of candidates. In some cases, an initial pool of candidates can include hired candidates or candidates that have been claimed by other recruiters. Such candidates can be filtered from an initial pool of candidates. In some cases, an initial pool of candidates can include candidates that have been tagged or reviewed by recruiters as being unqualified candidates. For example, a candidate may have submitted a falsified resume. Such candidates can be filtered from an initial pool of candidates. Many variations are possible.

FIG. 2B illustrates an example of a personalization ranking module 252 configured to personalize a refined pool of candidates and rank the personalized pool of candidates, according to an embodiment of the present technology. In some embodiments, the personalization ranking module 252 can be configured to generate recruiter embeddings for recruiters. Personalizing a refined pool of candidates can be based on recruiter embeddings. In some embodiments, the personalization ranking module 106 of FIG. 1 can be implemented as the personalization ranking module 252. As shown in FIG. 2B, the personalization ranking module 252 can include a recruiter embedding module 254, a personalization module 256, and a ranking module 258.

The recruiter embedding module 254 can generate recruiter embeddings for recruiters based on various candidate features of candidates associated with the recruiters. Candidates associated with the recruiters can include candidates that are considered (e.g., contacted, interviewed, hired, etc.) or claimed (i.e., tagged for consideration) by the recruiter as well as candidates that are not considered or claimed. The recruiter embedding module 254 can generate recruiter embeddings for recruiters based on machine learning methodologies. The recruiter embedding module 254 can train a machine learning model and apply the trained machine learning model to generate recruiter embeddings for recruiters. The machine learning model can be trained with a training set of recruiters and candidate features of candidates associated with the recruiters. Candidate features of candidates considered or claimed by a recruiter in the training set can be used as positive training data. Candidate features of candidates not considered or claimed by the recruiter in the training set can be used as negative training data. Candidate features of candidates considered or claimed by multiple recruiters in the training set can be used to identify similar recruiters in the training set. Candidate features of candidates considered or claimed by one recruiter but not another recruiter in the training set can be used to identify dissimilar recruiters in the training set. Candidate features of candidates considered by a recruiter can be associated with stronger positive signals than candidate features of candidates claimed by the recruiter. For example, a recruiter may have claimed a number of candidates yet only considered (e.g., interviewed) one candidate of the number of candidates. Candidate features associated with the number of candidates can be used as positive candidate features associated with the recruiter and candidate features associated with the one candidate can be weighted greater than the candidate features associated with the other claimed candidates. A trained machine learning model can be applied to a recruiter and generate a recruiter embedding for the recruiter. The recruiter embedding can be mapped to a vector space and compared with other recruiter embeddings. Recruiters with recruiter embeddings that are closer in proximity are more similar to each other than recruiters with recruiter embeddings that are farther in proximity. Many variations are possible.

The personalization module 256 can personalize a refined pool of candidates based on machine learning methodologies, rule-based methodologies, or a combination of methodologies. In some embodiments, the personalization module 256 can personalize a refined pool of candidates using one or more machine learning methodologies based on a recruiter embedding for a recruiter and candidate embeddings of candidates in a refined pool of candidates. The personalization module 256 can train a machine learning model and apply the machine learning model to determine affinities between the recruiter and the candidates based on the recruiter embedding and the respective candidate embeddings. The machine learning model can be trained with a training set of recruiter embeddings and candidate embeddings. Candidate embeddings corresponding to candidates that were considered or claimed by recruiters and recruiter embeddings corresponding to the recruiters can be used as positive training data. Candidate embeddings corresponding to candidates that were not considered or claimed by recruiters and recruiter embeddings corresponding to the recruiters can be used as negative training data. For example, candidate embeddings corresponding to candidates that a recruiter has considered or claimed and a recruiter embedding for the recruiter can be used as positive training data. Candidate embeddings corresponding to candidates that the recruiter did not consider or claim and the recruiter embedding can be used as negative training data. The personalization module 256 can apply a trained machine learning model to a recruiter embedding and candidate embeddings of candidates in a refined pool of candidates. The trained machine learning model can determine an affinity between a recruiter corresponding to the recruiter embedding and each candidate in the refined pool of candidates based on the recruiter embedding and the respective candidate embeddings. Candidates that satisfy a threshold affinity with a recruiter can be included in a personalized pool of candidates. As just one example, the threshold affinity can be associated with a threshold distance between a recruiter embedding and a candidate embedding in the vector space.

In some embodiments, the personalization module 256 can personalize a refined pool of candidates using one or more rule-based methodologies. The personalization module 256 can filter candidates from the refined pool of candidates based on one or more rules. For example, candidates in the refined pool of candidates that a recruiter has previously viewed and not claimed can be filtered from a refined pool of candidates. In some cases, a recruiter can specify certain rules to filter candidates from a refined pool of candidates. In some embodiments, the personalization module 256 can personalize a refined pool of candidates using a combination of methodologies. For example, a refined pool of candidates can be personalized for a recruiter based on a recruiter embedding corresponding to the recruiter and candidate embeddings corresponding to the candidates in the refined pool of candidates. A trained machine learning model can determine an affinity between the recruiter and the candidates based on the recruiter embedding and the candidate embeddings. Candidates that fail to satisfy a threshold affinity with the recruiter, as determined by the trained machine learning model, can be filtered from the refined pool of candidates. Further, candidates that the recruiter has previously viewed and not claimed can also be filtered from the refined pool of candidates. Many variations are possible.

The ranking module 258 can rank candidates in a personalized pool of candidates based on one or more machine learning methodologies. In some embodiments, the ranking module 258 can train a machine learning model and apply the machine learning model to determine a likelihood that a candidate will pass an interview. The machine learning model can be trained with a training set of candidate features associated with candidates and corresponding labels. Candidates can be positively labeled or negatively labeled based on how well they performed. For example, a candidate can be positively labeled based on passing a screening, passing a telephonic interview, or passing an on-site interview. A candidate can be negatively labeled based on failing a screening, failing a telephonic interview, or failing an on-site interview. Candidate features associated with positively labeled candidates can be used as positive training data. Candidate features associated with negatively labeled candidates can be used as negative training data. A trained machine learning model can be applied to candidates in a personalized pool of candidates and determine a likelihood that each candidate in the personalized pool of candidates will pass an interview and rank each candidate accordingly. Candidates that are more likely to pass an interview can be ranked higher than candidates that are less likely to pass an interview.

In some embodiments, the ranking module 258 can train a machine learning model and apply the machine learning model to determine an overall quality of a candidate. The machine learning model can be trained with a training set of candidate features associated with candidates. Candidate features associated with candidates who are claimed by recruiters can be used as positive training data. Candidate features associated with candidates who are not claimed by recruiters can be used as negative training data. The machine learning model can be trained, using the training set of candidates, to identify candidate features or combinations of candidate features that correspond with an overall quality of a candidate. A trained machine learning model can be applied to candidates in a personalized pool of candidates and determine an overall quality of each candidate in the personalized pool of candidates and rank each candidate accordingly. Candidates that are determined to be of an overall better quality can be ranked higher than candidates that are determined to be of an overall poorer quality. In some embodiments, the ranking module 258 can use a combination of machine learning models to rank a personalized pool of candidates. For example, candidates in a personalized pool of candidates can be ranked based on a likelihood to pass an interview and ranked based on an overall quality. Both rankings can be combined through an average, weighted average, or other combination to create a combined ranking of the candidates. Candidates that satisfy a threshold ranking can be recommended to a recruiter.

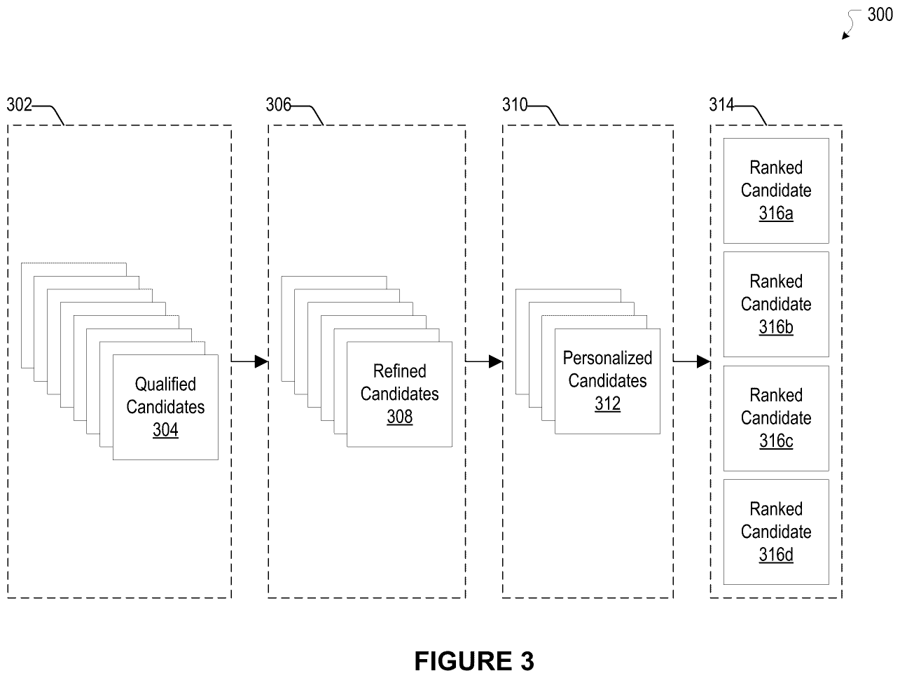

FIG. 3 illustrates an example functional block diagram 300, according to an embodiment of the present technology. The example function block diagram 300 illustrates an example multi-stage combination of machine learning methodologies and rule-based methodologies for generating candidate recommendations, as can be performed by the candidate recommendation module 102 of FIG. 1. It should be understood that there can be additional, fewer, or alternative steps performed in similar or alternative orders, or in parallel, based on the various features and embodiments discussed herein unless otherwise stated.

In this example, a first stage 302 of the example multi-stage combination can generate an initial pool of qualified candidates 304. The initial pool of qualified candidates 304 can be generated, for example, by the targeting module 206 of FIG. 2A. As discussed herein, the initial pool of qualified candidates can include candidates who are qualified for a requisition as determined by machine-learning methodologies, rule-based methodologies, or a combination of methodologies. A second stage 306 of the example multi-stage combination can refine the initial pool of candidates 304 and generate a refined pool of candidates 308. The refined pool of candidates can be generated, for example, by the filtering module 208 of FIG. 2A. A third stage 310 of the example multi-stage combination can personalize the refined pool of candidates 308 and generate a personalized pool of candidates 312. The personalized pool of candidates can be generated, for example, by the personalization module 256 of FIG. 2B. A fourth stage 314 of the example multi-stage combination can rank the personalized pool of candidates 312. The ranked candidates 316a, 316b, 316c, and 316d can be determined, for example, by the ranking module 258 of FIG. 2B. All examples herein are provided for illustrative purposes, and there can be many variations and other possibilities.

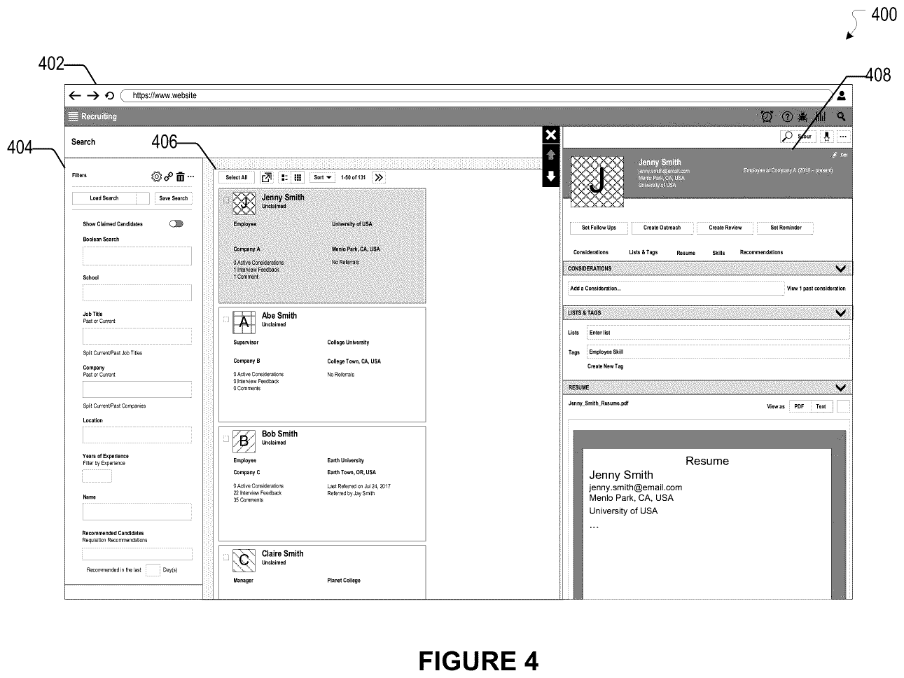

FIG. 4 illustrates an example interface 400 supported by the candidate recommendation module 102 of FIG. 1, according to an embodiment of the present technology. The example interface 400 may be presented through a display screen of a computing device. The example interface 400 may be provided through an application (e.g., a web browser, a social network application, a messaging application, etc.) running on the computing device. In this example, the example interface 400 displays a page 402 associated with providing candidate recommendations. The page 402 may be displayed for a recruiter. In this example, the recruiter may provide a variety of filtering criteria in a filter section 404. The filtering criteria provided through the filter section 404 can be used as one or more rules utilized in the present technology. Candidate recommendations can be provided to the recruiter through the recommendation section 406. The candidate recommendations can be provided based on a ranking of candidates in a personalized pool of candidates, as described herein. The recruiter may select a candidate from the candidate recommendations and see more information about the candidate in a details section 408. All examples herein are provided for illustrative purposes, and there can be many variations and other possibilities.

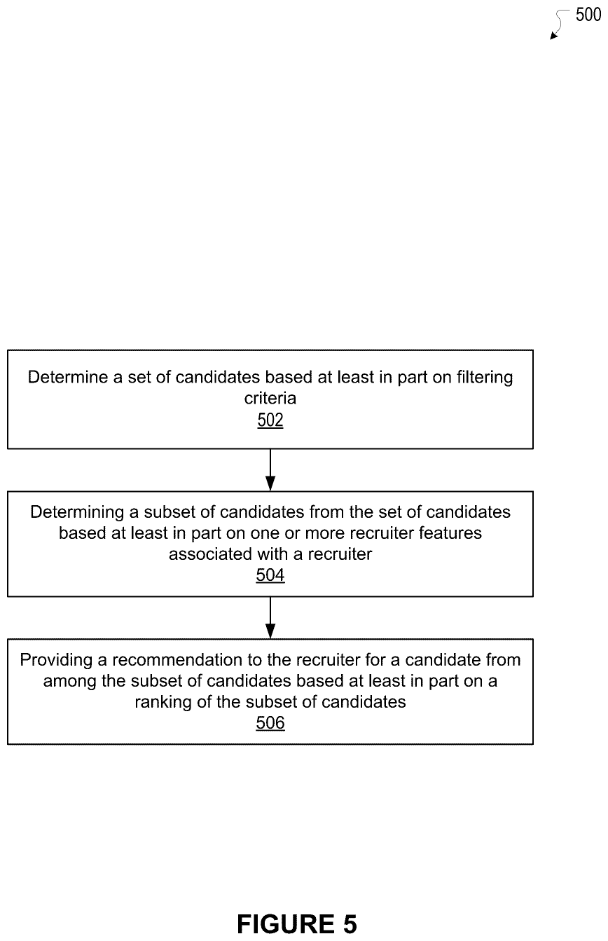

FIG. 5 illustrates an example method 500 for providing a recommendation for a candidate, according to an embodiment of the present technology. It should be understood that there can be additional, fewer, or alternative steps performed in similar or alternative orders, or in parallel, based on the various features and embodiments discussed herein unless otherwise stated.

At block 502, the example method 500 can determine a set of candidates based at least in part on filtering criteria. The set of candidates can be based on an initial pool of candidates or a refined pool of candidates, as described herein. At block 504, the example method 500 can determine a subset of candidates from the set of candidates based at least in part on one or more recruiter features associated with a recruiter. The subset of candidates can be based on a personalized pool of candidates, as described herein. At block 506, the example method 500 can provide a recommendation to the recruiter for a candidate from among the subset of candidates based at least in part on a ranking of the subset of candidates. The recommendation can be based on a ranking of a personalized pool of candidates, as described herein. All examples herein are provided for illustrative purposes, and there can be many variations and other possibilities.

It is contemplated that there can be many other uses, applications, and/or variations associated with the various embodiments of the present technology. For example, in some cases, user can choose whether or not to opt-in to utilize the present technology. The present technology can also ensure that various privacy settings and preferences are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a computer system executing, for example, a Microsoft Windows compatible operating system (OS), macOS, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects another user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music, or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list.” External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a candidate recommendation module 646. The candidate recommendation module 646, for example, can be implemented as some or all of the functionality of the candidate recommendation module 102 of FIG. 1. In some embodiments, some or all of the functionality of the candidate recommendation module 646 can be implemented in the user device 610. As discussed previously, it should be appreciated that there can be many variations or other possibilities.

### Hardware Implementation

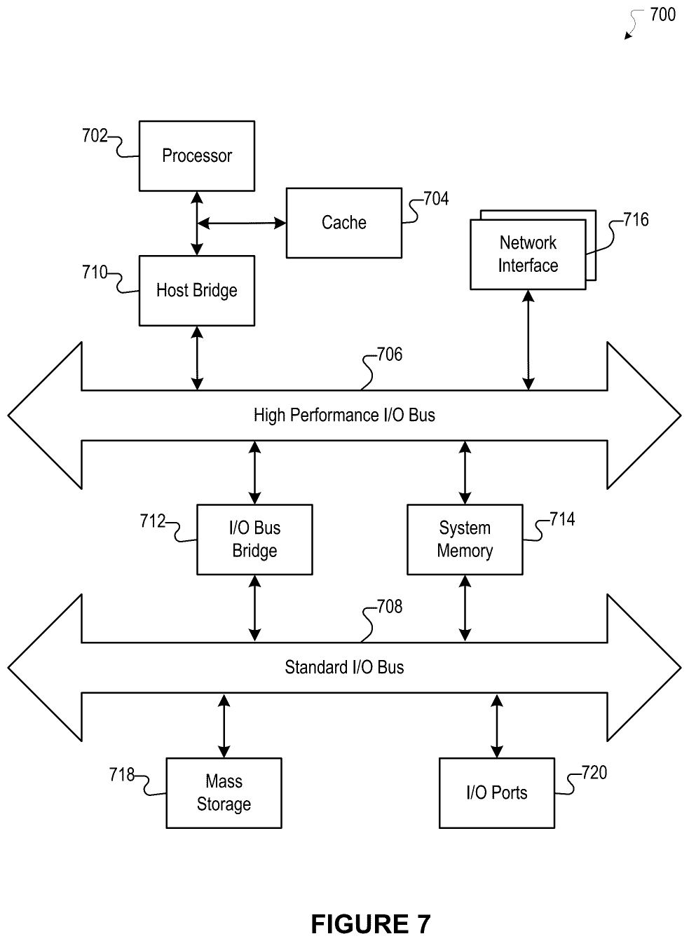

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, California, and the x86-compatible processors manufactured by Advanced Micro Devices (AMD), Inc., of Sunnyvale, California, as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Inc. of Cupertino, California, UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module,” with processor 702 being referred to as the “processor core.” Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs.” For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the technology can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment,” “an embodiment,” “other embodiments,” “one series of embodiments,” “some embodiments,” “various embodiments,” or the like means that a particular feature, design, structure, or characteristic described in connection with the embodiment is included in at least one embodiment of the technology. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the embodiments of the invention are intended to be illustrative, but not limiting, of the scope of the invention, which is set forth in the following claims.

1. A computer-implemented method comprising:
determining, by a computing system, a pool of candidates from current candidates, considered candidates, and hired candidates based at least in part on a first machine learning model, wherein the first machine learning model determines the pool of candidates based at least in part on candidate embeddings associated with the current candidates, the considered candidates, and the hired candidates that satisfy a threshold proximity with the candidate embedding of one of the considered candidates;
determining, by the computing system, a set of candidates from the pool of candidates based at least in part on filtering criteria;
determining, by the computing system, a subset of candidates from the set of candidates based at least in part on a second machine learning model, wherein the second machine learning model determines the subset of candidates based at least in part on the candidates in the set of candidates with affinities that satisfy a threshold affinity with a recruiter, the affinities determined based at least in part on a recruiter embedding associated with the recruiter and the candidate embeddings associated with the set of candidates, the recruiter embedding based at least in part on first candidate features of candidates that were claimed by the recruiter, the first candidate features of the considered candidates that were claimed by the recruiter weighted greater than the first candidate features of the candidates that were claimed by the recruiter, the candidate embeddings based at least in part on second candidate features associated with the set of candidates; and
providing, by the computing system, a recommendation to the recruiter for a candidate from among the subset of candidates based at least in part on a ranking of the subset of candidates, wherein the ranking is based at least in part on an overall quality determined for each candidate of the subset of candidates by a third machine learning model.

2. The computer-implemented method of claim 1, wherein the set of candidates comprises candidates that have been claimed by the recruiter but have not been contacted by the recruiter within a threshold period of time.

3. The computer-implemented method of claim 1, wherein the first machine learning model is trained based on first training data that includes first training candidate features of candidates considered for the same requisition as a first example of similar candidate features and includes second training candidate features of candidates considered for different requisitions as a second example of dissimilar candidate features.

4. The computer-implemented method of claim 1, wherein the filtering criteria is based on at least one of: a minimum amount of experience, a geographical location, a tag, or a review.

5. The computer-implemented method of claim 1, wherein the determining the subset of candidates from the set of candidates comprises filtering candidates that the recruiter has previously viewed and not claimed.

6. The computer-implemented method of claim 1, wherein the recruiter embedding and the candidate embeddings are mapped to a vector space.

7. The computer-implemented method of claim 1, wherein the threshold affinity is associated with a threshold distance between the recruiter embedding and the candidate embeddings in a vector space.

8. The computer-implemented method of claim 1, wherein the ranking of the subset of candidates is based at least in part on a likelihood to pass an interview of each candidate in the subset of candidates, wherein the likelihood is determined based at least in part on a third machine learning model.

9. The computer-implemented method of claim 8, wherein the ranking of the subset of candidates is based at least in part on a weighted combination of the likelihood to pass an interview and the overall quality of each candidate in the subset of candidates.

10. The computer-implemented method of claim 1, wherein the providing the recommendation to the recruiter for the candidate is further based at least in part on whether the candidate satisfies a threshold ranking.

11. A system comprising:
at least one processor; and
a memory storing instructions that, when executed by the at least one processor, cause the system to perform operations comprising:
determining a pool of candidates from current candidates, considered candidates, and hired candidates based at least in part on a first machine learning model, wherein the first machine learning model determines the pool of candidates based at least in part on candidate embeddings associated with the current candidates, the considered candidates, and the hired candidates that satisfy a threshold proximity with the candidate embedding of one of the considered candidates;
determining a set of candidates from the pool of candidates based at least in part on filtering criteria;
determining a subset of candidates from the set of candidates based at least in part on a second machine learning model, wherein the second machine learning model determines the subset of candidates based at least in part on the candidates in the set of candidates with affinities that satisfy a threshold affinity with a recruiter, the affinities determined based at least in part on a recruiter embedding associated with the recruiter and the candidate embeddings associated with the set of candidates, the recruiter embedding based at least in part on first candidate features of candidates that were claimed by the recruiter, the first candidate features of the considered candidates that were claimed by the recruiter weighted greater than the first candidate features of the candidates that were claimed by the recruiter, the candidate embeddings based at least in part on second candidate features associated with the set of candidates; and
providing a recommendation to the recruiter for a candidate from among the subset of candidates based at least in part on a ranking of the subset of candidates, wherein the ranking is based at least in part on an overall quality determined for each candidate of the subset of candidates by a third machine learning model.

12. The system of claim 11, wherein the set of candidates comprises candidates that have been claimed by the recruiter but have not been contacted by the recruiter within a threshold period of time.

13. The system of claim 11, wherein the first machine learning model is trained based on first training data that includes first training candidate features of candidates considered for the same requisition as a first example of similar candidate features and includes second training candidate features of candidates considered for different requisitions as a second example of dissimilar candidate features.

14. The system of claim 11, wherein the filtering criteria is based on at least one of: a minimum amount of experience, a geographical location, a tag, or a review.

15. The system of claim 11, wherein the determining the subset of candidates from the set of candidates comprises filtering candidates that the recruiter has previously viewed and not claimed.

16. A non-transitory computer-readable storage medium including instructions that, when executed by at least on processor of a computing system, cause the computing system to perform operations comprising:
determining a pool of candidates from current candidates, considered candidates, and hired candidates based at least in part on a first machine learning model, wherein the first machine learning model determines the pool of candidates based at least in part on candidate embeddings associated with the current candidates, the considered candidates, and the hired candidates that satisfy a threshold proximity with the candidate embedding of one of the considered candidates;
determining a set of candidates from the pool of candidates based at least in part on filtering criteria;
determining a subset of candidates from the set of candidates based at least in part on a second machine learning model, wherein the second machine learning model determines the subset of candidates based at least in part on the candidates in the set of candidates with affinities that satisfy a threshold affinity with a recruiter, the affinities determined based at least in part on a recruiter embedding associated with the recruiter and the candidate embeddings associated with the set of candidates, the recruiter embedding based at least in part on first candidate features of candidates that were claimed by the recruiter, the first candidate features of the considered candidates that were claimed by the recruiter weighted greater than the first candidate features of the candidates that were claimed by the recruiter, the candidate embeddings based at least in part on second candidate features associated with the set of candidates; and
providing a recommendation to the recruiter for a candidate from among the subset of candidates based at least in part on a ranking of the subset of candidates, wherein the ranking is based at least in part on an overall quality determined for each candidate of the subset of candidates by a third machine learning model.

17. The non-transitory computer-readable storage medium of claim 16, wherein the set of candidates comprises candidates that have been claimed by the recruiter but have not been contacted by the recruiter within a threshold period of time.

18. The non-transitory computer-readable storage medium of claim 16, wherein the first machine learning model is trained based on first training data that includes first training candidate features of candidates considered for the same requisition as a first example of similar candidate features and includes second training candidate features of candidates considered for different requisitions as a second example of dissimilar candidate features.

19. The non-transitory computer-readable storage medium of claim 16, wherein the filtering criteria is based on at least one of: a minimum amount of experience, a geographical location, a tag, or a review.

20. The non-transitory computer-readable storage medium of claim 16, wherein the determining the subset of candidates from the set of candidates comprises filtering candidates that the recruiter has previously viewed and not claimed.
